(19) United States
(12) Patent Application Publication
(10) Pub. No.: US 2026/0188350 A1
(43) Pub. Date: Jul. 2, 2026

(54) REAL-TIME FACIAL TRANSLATION METHOD AND DEVICE

(71) Applicant: Zhowcase Limited, HongKong (CN)

(72) Inventor: Pak Kit LAM, HongKong (CN)

(21) Appl. No.: 19/433,680

(22) Filed: Dec. 26, 2025

(30) Foreign Application Priority Data
Dec. 27, 2024 (CN) 202411954170.3

(51) Int. Cl. G11B 27/036; G06F 40/58; G10L 13/08; G10L 25/63

(52) U.S. Cl. CPC G11B 27/036; G06F 40/58; G10L 13/086; G10L 25/63

(57) ABSTRACT

Provided is a real-time facial translation method, which includes dividing a real-time video stream of a facial translation framework into a plurality of video sections; the facial translation framework includes a plurality of processes for processing each video section, and the processes are divided into a plurality of process groups, each process group is assigned time slots of the same or different lengths; sequentially running the process groups in different time slots by a plurality of processors or threads for each video section, and the plurality of processors or threads being configured such that at least when one processor or thread runs a last process group of a current video section in a current time slot, the other processor or thread also running a process group of a next video section after the current video section in the current time slot, and obtaining the real-time facial translation video.

### CROSS-REFERENCE TO RELATED APPLICATIONS

This application claims priority to Chinese Patent Application No. 202411954170.3, filed on Dec. 27, 2024, which is hereby incorporated by reference in its entirety.

### TECHNICAL FIELD

The present disclosure relates to the field of video processing technologies, and in particular, to a real-time facial translation method and a device thereof.

### BACKGROUND

In the past, translation technology was mainly based on text and/or speech. Recently, technology has advanced to the point where it can even synthesize the voice, mouth shape, and emotions of the original speaker/character in translated videos. This is very useful in video translation work because the translated video can now be very similar to the original video, and the audience will feel that the speaker/character is speaking directly to them in the translated language after translating the video.

For the sake of convenience, this specification refers to the translation of sounds, mouth movements, and emotions in videos as “facial translation”.

However, current technologies are unable to perform real-time facial translation.

When using a processor (Central Processing Unit, CPU/Graphics Processing Unit, GPU) or a single “execution thread” to handle all processes of the facial translation framework, it usually takes a lot of time to complete the facial translation process. Therefore, generating facial translation videos will result in longer latency than the original video stream itself (usually several times the length of the original video stream). For example, the input of 10 second video stream requires a facial translation framework to process for a longer time than 10 seconds. Therefore, traditional facial translation methods cannot achieve real-time facial translation and are therefore not suitable for video live streaming scenarios.

To reduce latency, the most direct intermediate solution is usually to simplify the neural network structure involved in facial translation frameworks, but this can also lower the quality of facial translation videos output by the framework.

Although it is possible to accelerate the processing of facial translation frameworks by using more powerful processors, such methods often still require more processing time and are difficult to apply to scenarios that require real-time facial translation, such as video live streaming. In addition, there are many unknown factors and difficulties in determining whether there is a sufficiently powerful processor.

It should be noted that the information disclosed in the background section above is only for the purpose of understanding the background of the present application, and therefore may include information that does not constitute prior art known to those skilled in the art.

### SUMMARY

The main objective of the present disclosure is to overcome shortcomings of the background technology and provide a real-time facial translation method and a device thereof.

To achieve the above objectives, the present disclosure adopts the following technical solutions.

In a first aspect of the present disclosure, a real-time facial translation method, including:
dividing a real-time video stream of a facial translation framework into a plurality of video sections with same or different lengths; where the facial translation framework includes a plurality of processes for processing each video section, and the plurality of processes are divided into a plurality of process groups (PG) that are executed sequentially, each process group is assigned time slots of the same or different lengths;
sequentially running the plurality of process groups in different time slots by a plurality of processors or threads for each video section, and the plurality of processors or threads being configured such that at least when one processor or thread runs a last process group of a current video section in a current time slot, the other processor or thread also running a process group of a next video section after the current video section in the current time slot; thereby achieving parallel processing of different video sections of the real-time video stream by the plurality of processors or threads, and obtaining the real-time facial translation video.

In some embodiments of the present disclosure, the plurality of process groups includes a first process group and a second process group, and the plurality of processors or threads include a first processor or thread and a second processor or thread;
for each video section, the first process group and the second process group are respectively executed by the first processor or thread and the second processor or thread in different time slots; where when the second processor or second thread runs the second process group of the current video section in the current time slot, the first processor or first thread runs the first process group of the next video section after the current video section in the current time slot.

In some embodiments of the present disclosure, the facial translation framework includes:
an audio extraction process, configured to extract an original audio from an original video;
a video extraction process, configured to extract the original video from which the original audio has been removed;
a text recognition process, configured to recognize an extracted text within the original audio;
a text translation process, configured to translate a recognized text from an original language to a target language;
a speech and emotion synthesis process, configured to capture a speaker's voice and emotions from the original audio and apply them to a text of the target language to synthesize a translated audio of the speaker speaking in the target language; and
a facial translation process, configured to synthesize a facial expression video of the speaker speaking in the target language based on the original video after removing the original audio and the original mouth movement; where the facial expression video is then combined with the translated audio to obtain the facial translation video;
where the audio extraction process, text recognition process, and video extraction process are grouped into the first process group, and the text translation process, speech and emotion synthesis process, and facial translation process are grouped into the second process group.

Of course, this application is not limited to two process groups, and in actual operation, it can also have more than two process groups.

In some embodiments of the present disclosure, the plurality of process groups include n process groups, and the plurality of processors or threads include n processors or n threads, where n≥2.

In some embodiments of the present disclosure, the facial translation framework is constructed based on artificial neural networks.

In a second aspect of the present disclosure, a non-transient computer-readable storage medium, where a computer program is stored thereon, and the computer program, when executed by a processor, implements the real-time facial translation method.

In a third aspect of the present disclosure, a real-time facial translation device, including:
a first configuration processing module, configured to divide a real-time video stream of a facial translation framework into a plurality of video sections with same or different lengths; where the facial translation framework includes a plurality of processes for processing each video section, and the plurality of processes are divided into a plurality of process groups that are executed sequentially, each process group is assigned time slots of the same or different lengths;
a second configuration processing module, configured to sequentially run the plurality of process groups in different time slots by a plurality of processors or threads for each video section, and the plurality of processors or threads be configured such that at least when one processor or thread runs a last process group of a current video section in a current time slot, the other processor or thread also runs a process group of a next video section after the current video section in the current time slot; thereby achieving parallel processing of different video sections of the real-time video stream by the plurality of processors or threads, and obtain the real-time facial translation video.

In some embodiments of the present disclosure, the plurality of process groups include a first process group and a second process group, and the plurality of processors or threads include a first processor or thread and a second processor or thread;
the second configuration processing module is further configured to: for each video section, the first process group and the second process group are respectively executed by the first processor or thread and the second processor or thread in different time slots; where when the second processor or second thread runs the second process group of the current video section in the current time slot, the first processor or first thread runs the first process group of the next video section after the current video section in the current time slot.

In some embodiments of the present disclosure, the facial translation framework includes:
an audio extraction process, configured to extract an original audio from an original video;
a video extraction process, configured to extract the original video from which the original audio has been removed;
a text recognition process, configured to recognize an extracted text within the original audio;
a text translation process, configured to translate a recognized text from an original language to a target language;
a speech and emotion synthesis process, configured to capture a speaker's voice and emotions from the original audio and apply them to a text of the target language to synthesize a translated audio of the speaker speaking in the target language; and
a facial translation process, configured to synthesize a facial expression video of the speaker speaking in the target language based on the original video after removing the original audio and the original mouth movement; where the facial expression video is then combined with the translated audio to obtain the facial translation video;
where the audio extraction process, text recognition process, and video extraction process are grouped into the first process group, and the text translation process, speech and emotion synthesis process, and facial translation process are grouped into the second process group.

In some embodiments of the present disclosure, the plurality of process groups include n process groups, and the plurality of processors include n processors and n threads, where n≥2.

In some embodiments of the present disclosure, the facial translation framework is constructed based on artificial neural networks.

The present disclosure has the following beneficial effects.

The present disclosure provides a real-time facial translation method, which divides a real-time video stream into a plurality of video sections, divides the facial translation framework into a plurality of process groups for processing each video section, and runs the plurality of process groups through a plurality of processors or threads to achieve parallel processing of different video sections of the real-time video stream, obtaining real-time facial translation videos. Thus, the present disclosure can achieve real-time facial translation with only a short initial delay. Therefore, the facial translation method of the present disclosure is more suitable for real-time facial translation scenarios such as video live streaming than existing facial translation methods.

Besides that, having a fixed and relatively short initial delay, the present disclosure enables complex facial translation frameworks to continuously output facial translation videos in a near real-time manner, achieving a near real-time facial translation effect. The present disclosure can shorten the total processing time of the facial translation framework to be shorter than the time of the input video stream, thereby achieving an effect close to real-time facial translation.

One of the significant advantages of the present disclosure is that it only requires a sufficient number (2 or more) of available processors or threads to achieve real-time facial translation, without compromising the quality of facial translation videos output by the facial translation framework for real-time performance or requiring a single processor to have very powerful performance.

The real-time facial translation implemented by the method of the present disclosure can realize many important video applications, including but not limited to:
e-commerce live streaming—“internet celebrities” can promote products to global audiences through video live streaming on e-commerce platforms;
global synchronized product release—major brands can release their products globally through live video streaming and real-time video releases in many languages;
simultaneously holding video conferences with colleagues and/or clients in many languages;
in the field of distance education, the facial translation method of the present disclosure can help students better understand the meaning and emotions of foreign teachers and improve the quality of teaching.

The present disclosure has broad application prospects in various scenarios where real-time facial translation can be applied.

Other beneficial effects in the embodiments of the present disclosure will be further described in the following description.

### BRIEF DESCRIPTION OF DRAWINGS

FIG. 1 is a schematic diagram of a facial translation framework of the real-time facial translation method according to an embodiment of the present disclosure.

FIG. 2 is a schematic diagram of the facial translation framework of the real-time facial translation method according to an embodiment of the present disclosure, in which a plurality of processes of the facial translation framework are divided into two process groups that are executed sequentially.

FIG. 3 is a schematic diagram of parallel processing of a real-time facial translation method according to an embodiment of the present disclosure, in which two processors or threads perform parallel processing on a plurality of video sections of a video stream.

### DESCRIPTION OF EMBODIMENTS

The following provides a detailed explanation of the embodiments of the present disclosure. It should be emphasized that the following description is only exemplary and not intended to limit the scope and application of the present disclosure.

It should be understood that terms “length”, “width”, “up”, “down”, “front”, “back”, “left”, “right”, “vertical”, “horizontal”, “top”, “bottom”, “inside”, “outside” and other directional or positional relationships are only for the convenience of describing embodiments of the present disclosure and simplifying the description, and do not indicate or imply that the device or component referred to must have a specific orientation, be constructed and operated in a specific orientation, and therefore cannot be understood as limiting the present disclosure.

Besides that, terms “first” and “second” are only used for descriptive purposes and cannot be understood as indicating or implying relative importance or implying the number of technical features indicated. Thus, defining the features with “first” and “second” may explicitly or implicitly include one or more of these features. In the description of the embodiments of the present disclosure, the meaning of “a plurality of” refers to two or more, unless otherwise specifically limited.

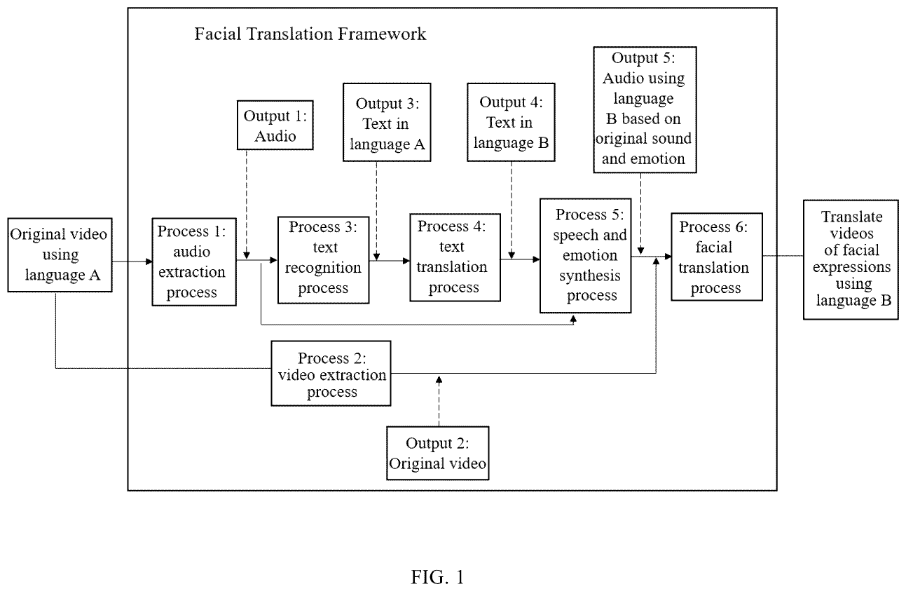

Referring to FIGS. 1 to 3, an embodiment of the present disclosure provides a real-time facial translation method, including:
dividing a real-time video stream of a facial translation framework into a plurality of video sections with same or different lengths; where the facial translation framework includes a plurality of processes for processing each video section, and the plurality of processes are divided into a plurality of process groups (PG) that are executed sequentially, each process group is assigned time slots of the same or different lengths;
sequentially running the plurality of process groups in different time slots by a plurality of processors or threads for each video section, and the plurality of processors or threads being configured such that at least when one processor runs a last process group of a current video section in a current time slot, the other processor also running a process group of a next video section after the current video section in the current time slot; thereby achieving parallel processing of different video sections of the real-time video stream by the plurality of processors or threads, and obtaining the real-time facial translation video.

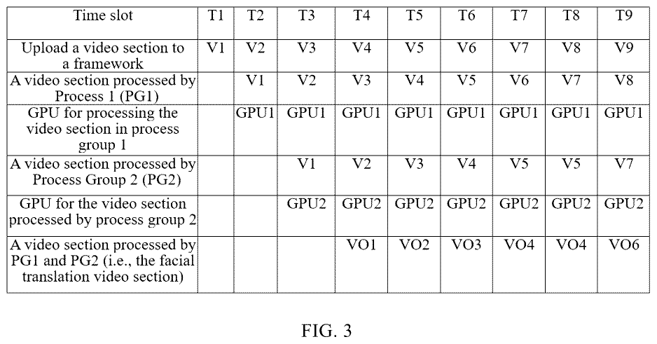

Referring to FIG. 3, in an exemplary embodiment, the plurality of process groups includes two process groups, namely, a first process group PG1 and a second process group PG2 for processing each video section, and the plurality of processors or threads include two processors or two threads, namely, a first processor or first thread GPU1 and a second processor or second thread GPU2. For each video section, the first process group PG1 and the second process group PG2 are respectively executed by the first processor or first thread GPU1 and the second processor or second thread GPU2 in different time slots; and, when the second processor or second thread GPU2 runs the second process group PG2 of the current video section in the current time slot, the first processor or first thread GPU1 also runs the first process group PG1 of the next video section after the current video section in the current time slot. Of course, the number of the plurality of process groups used to process each video section in the present disclosure is not limited to 2, but can be even more. Similarly, the number of processors or threads used to run the plurality of process groups in the present disclosure is not limited to 2, but can be even more.

An embodiment of the present disclosure further provides a real-time facial translation device, including:
a first configuration processing module, configured to divide a real-time video stream of a facial translation framework into a plurality of video sections with same or different lengths; where the facial translation framework includes a plurality of processes for processing each video section, and the plurality of processes are divided into a plurality of process groups that are executed sequentially, each process group is assigned time slots of the same or different lengths;
a second configuration processing module, configured to sequentially run the plurality of process groups in different time slots by a plurality of processors or threads for each video section, and the plurality of processors or threads be configured such that at least when one processor or thread runs a last process group of a current video section in a current time slot, the other processor or thread also runs a process group of a next video section after the current video section in the current time slot; thereby achieving parallel processing of different video sections of the real-time video stream by the plurality of processors or threads, and obtain the real-time facial translation video.

The following further describes specific embodiments of the present disclosure.

FIG. 1 shows a facial translation framework of a real-time facial translation method according to an embodiment of the present disclosure, which can translate the original video of the speaker speaking in language A into a facial translation video of the speaker speaking in language B. Language A is different from Language B. The facial translation video of the speaker speaking in language B is basically the same as the original video, but in the facial translation video, the speaker is speaking language B and has facial expressions that match language B when speaking.

According to the facial translation framework shown in FIG. 1, the processing steps for implementing facial translation include the following processes 1 to 6:
Process 1: audio extraction process

The audio extraction process is configured to extract an original audio of the speaker speaking language A from an original video.
Process 2: video extraction process

The video extraction process is configured to extract the original video from which the original audio has been removed.
Process 3: text recognition process

The text recognition process is configured to recognize a text of language A extracted from the original audio.
Process 4: text translation process

The text translation process is configured to translate a recognized text from the original language A to a target language B.
Process 5: speech and emotion synthesis process

The speech and emotion synthesis process is configured to capture the speaker's voice and emotions from the original audio and apply them to a text of the target language B to synthesize a translated audio of the speaker speaking in the target language B.
Process 6: facial translation process

The facial translation process is configured to synthesize a facial expression video of the speaker speaking in the target language B based on the original video after removing the original audio and the original mouth movement. The facial expression video is then combined with the translated audio to obtain the facial translation video.

For the above facial translation framework, if only one processor is used to process all its processes, it will take a lot of time and result in longer delays than the original video stream length (usually several times the length of the video stream in language A), rendering it impossible to achieve real-time facial translation and unsuitable for video live streaming scenarios.

In order to accelerate the above facial translation framework and make its processing speed close to real-time facial translation, the embodiments of the present disclosure provide the following facial translation method for real-time video applications.

In the real-time facial translation method of the embodiment of the present disclosure, the real-time video stream input into the facial translation framework is divided into a plurality of video sections of the same or different lengths. Moreover, the facial translation framework is used to divide a plurality of processes for processing video streams into two or more process groups, and allocate relevant time slots for each process group so that each video section can be processed within the relevant time slot. The process groups of different video sections are processed in parallel by two or more processors or threads, so that in addition to a fixed and short initial delay, the complex facial translation framework can continuously output facial translation videos in a near real-time manner, thereby achieving a near real-time facial translation effect.

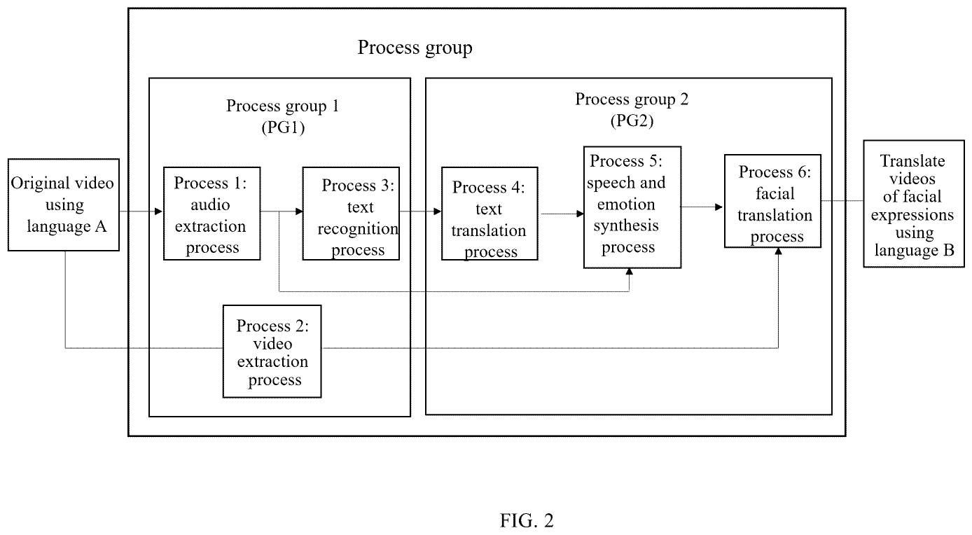

As shown in FIG. 2, specifically, processes 1 to 6 of the facial translation framework are divided into two process groups, namely, the first process group PG1 and the second process group PG2. The first process group PG1 includes the audio extraction process, the text recognition process, and the video extraction process, and the second process group PG2 includes the text translation process, the speech and emotion synthesis process, and the facial translation process.

In the embodiment shown in FIG. 2, the idea of the present disclosure is illustrated by running all processes in two processors or threads GPU1 and GPU2. For ease of explanation, this embodiment creates two process groups PG1 and PG2 for the facial translation framework, which divide a plurality of processes in the above way. However, in reality, each processor can also run processes in different combinations.

FIG. 3 shows how two process groups PG1 and PG2 handle video streams divided into a plurality of video sections of the same or different lengths (V1, V2, . . . , V9 in this example). Each video section is processed by a processor or thread GPU1 in one time slot and moved to another processor or thread GPU2 for processing in another time slot. The processing path of each video section from input to output is illustrated using numbers with the same digits.

For example, the first video section V1 is input to a system and output as VO1 from the system. For example, in time slot T1, the first video section V1 is uploaded to the facial translation framework. In time slot T2, the first video section V1 is processed by the processor or thread GPU1 in process group PG1. In time slot 3, the first video section V1 is processed by the processor or thread GPU2 in process group PG2. In time slot T4, an output of the first video section is VO1.

In the above embodiment, after a delay of three initial time slots, the output of each video section (i.e. VO1, VO2 . . . ) can be continuously output. In other words, by making the time slots small enough, dividing processes into fewer process groups, and having a matching number of processors or threads, the facial translation framework can be executed in real-time for any live video stream.

The real-time facial translation achieved by the method of the present disclosure can realize many important applications, including but not limited to:
1. e-commerce live streaming—“internet celebrities” can promote products to global audiences through video live streaming on e-commerce platforms;
2. global synchronized product release—major brands can release products globally through live video streaming, and also releasing real-time videos in many languages;
3. conduct video conferences with colleagues and/or clients in many languages simultaneously.

The facial translation technology provided by the present disclosure can be widely applied, including but not limited to the following aspects.

Language barriers are a common issue in cross-border communication. Through the facial translation method of the present disclosure, people can better understand each other's meaning and enhance communication effectiveness.

In video conferences, people from different countries or regions participate in discussions. The facial translation method of the present disclosure can translate languages from different countries or regions into the same language in real-time, and maintain the original speaker's mouth shape, facial expressions, and emotions.

In the field of distance education, the facial translation method of the present disclosure can help students better understand the meaning and emotions of foreign teachers and improve the quality of teaching.

An embodiment of the present disclosure further provides a storage medium for storing a computer program, which, when executed, performs at least the method described above.

Technicians in this field should understand that embodiments of the present disclosure can be provided as methods, systems, or computer program products. Therefore, the present disclosure can be implemented in the form of a fully hardware implementation, a full software implementation, or a combination of software and hardware aspects. Moreover, the present disclosure may take a form of a computer program product implemented on one or more computer usable storage media (including but not limited to disk storage, CD-ROM, optical storage, etc.) containing a computer usable program code.

The present disclosure is described with reference to flowcharts and/or block diagrams of methods, devices (systems), and computer program products according to embodiments of the present disclosure. It should be understood that each process and/or block in the flowchart and/or block diagram, as well as the combination of processes and/or blocks in the flowchart and/or block diagram, can be implemented by computer program instructions. These computer program instructions can be provided to a processor of a general-purpose computer, specialized computer, embedded processor, or other programmable data processing device to generate a machine, such that the instructions executed by the processor of the computer or other programmable data processing device generate a device for implementing the functions specified in one or more processes in the flowchart and/or one or more blocks in the block diagram.

These computer program instructions can also be stored in computer-readable memory that can guide a computer or other programmable data processing device to operate in a specific manner, causing the instructions stored in the computer-readable memory to produce a manufactured product including instruction devices that implement the functions specified in a flowchart or a plurality of flowcharts and/or a block diagram or a plurality of blocks.

These computer program instructions can also be loaded onto a computer or other programmable data processing device, enabling a series of operational steps to be executed on the computer or other programmable device to generate computer implemented processing. The instructions executed on the computer or other programmable device provide steps for implementing the functions specified in one or more processes in the flowchart and/or one or more blocks in the block diagram.

The background section of the present disclosure may contain background information about the problem or environment of the present disclosure, rather than necessarily describing the prior art. Therefore, the content included in the background technology section is not an acknowledgement of the applicant's prior art.

The above content is a further detailed explanation of the present disclosure based on specific/preferred embodiments, and it cannot be assumed that the specific embodiments of the present disclosure are limited to these explanations. For those skilled in the art to which the present disclosure belongs, without departing from the concept of the present disclosure, they can also make several substitutions or modifications to these described embodiments, and these substitutions or modifications should be considered as belonging to the protection scope of the present disclosure. In the description of this specification, the reference to terms “an embodiment”, “some embodiments”, “preferred embodiments”, “examples”, “specific examples”, or “some examples” means that the specific features, structures, materials, or characteristics described in combination with the embodiments or examples are included in at least one embodiment or example of the present disclosure. In this specification, the schematic expressions of the above terms do not necessarily refer to the same embodiments or examples. Moreover, the specific features, structures, materials, or characteristics described can be combined in any one or more embodiments or examples in an appropriate manner. Technicians in this field can combine and integrate different embodiments or examples described in this specification, as well as the features of different embodiments or examples, without conflicting with each other. Although the embodiments and advantages of the present disclosure have been described in detail, it should be understood that various changes, substitutions, and alterations may be made herein without departing from the protection scope of the present application.

What is claimed is:

1. A real-time facial translation method, comprising:
dividing a real-time video stream of a facial translation framework into a plurality of video sections; wherein the facial translation framework comprises a plurality of processes for processing each video section, and the plurality of processes are divided into a plurality of process groups that are executed sequentially, each process group is assigned time slots of the same or different lengths;
sequentially running the plurality of process groups in different time slots by a plurality of processors or threads for each video section, and the plurality of processors or threads being configured such that at least when one processor or thread runs a last process group of a current video section in a current time slot, the other processor or thread also running a process group of a next video section after the current video section in the current time slot; thereby achieving parallel processing of different video sections of the real-time video stream by the plurality of processors or threads, and obtaining the real-time facial translation video.

2. The real-time facial translation method according to claim 1, wherein the plurality of process groups comprise a first process group and a second process group, and the plurality of processors or threads comprise a first processor or thread and a second processor or thread;
for each video section, the first process group and the second process group are respectively executed by the first processor or thread and the second processor or thread in different time slots; wherein when the second processor or second thread runs the second process group of the current video section in the current time slot, the first processor or first thread runs the first process group of the next video section after the current video section in the current time slot.

3. The real-time facial translation method according to claim 1, wherein the facial translation framework comprises:
an audio extraction process, configured to extract an original audio from an original video;
a video extraction process, configured to extract the original video from which the original audio has been removed;
a text recognition process, configured to recognize an extracted text within the original audio;
a text translation process, configured to translate a recognized text from an original language to a target language;
a speech and emotion synthesis process, configured to capture a speaker's voice and emotions from the original audio and apply them to a text of the target language to synthesize a translated audio of the speaker speaking in the target language; and
a facial translation process, configured to synthesize a facial expression video of the speaker speaking in the target language based on the original video after removing the original audio and the original mouth movement; wherein the facial expression video is then combined with the translated audio to obtain the facial translation video;
wherein the audio extraction process, text recognition process, and video extraction process are grouped into the first process group, and the text translation process, speech and emotion synthesis process, and facial translation process are grouped into the second process group.

4. The real-time facial translation method according to claim 1, wherein the plurality of process groups comprises n process groups, and the plurality of processors or threads comprise n processors or threads, where n≥2.

5. The real-time facial translation method according to claim 1, wherein the facial translation framework is constructed based on artificial neural networks.

6. A non-transient computer-readable storage medium, wherein a computer program is stored thereon, and the computer program, when executed by a processor, implements the real-time facial translation method according to claim 1.

7. A real-time facial translation device, comprising:
a first configuration processing module, configured to divide a real-time video stream of a facial translation framework into a plurality of video sections with same or different lengths; wherein the facial translation framework comprises a plurality of processes for processing each video section, and the plurality of processes are divided into a plurality of process groups that are executed sequentially, each process group is assigned time slots of the same or different lengths;
a second configuration processing module, configured to sequentially run the plurality of process groups in different time slots by a plurality of processors or threads for each video section, and the plurality of processors or threads be configured such that at least when one processor or thread runs a last process group of a current video section in a current time slot, the other processor or thread also runs a process group of a next video section after the current video section in the current time slot; thereby achieving parallel processing of different video sections of the real-time video stream by the plurality of processors or threads, and obtain the real-time facial translation video.

8. The real-time facial translation device according to claim 7, wherein the plurality of process groups comprises a first process group and a second process group, and the plurality of processors or threads comprise a first processor or thread and a second processor or thread;
the second configuration processing module is further configured to: for each video section, the first process group and the second process group are respectively executed by the first processor or thread and the second processor or thread in different time slots; wherein when the second processor or second thread runs the second process group of the current video section in the current time slot, the first processor or first thread runs the first process group of the next video section after the current video section in the current time slot.

9. The real-time facial translation device according to claim 7, wherein the facial translation framework comprises:
an audio extraction process, configured to extract an original audio from an original video;
a video extraction process, configured to extract the original video from which the original audio has been removed;
a text recognition process, configured to recognize an extracted text within the original audio;
a text translation process, configured to translate a recognized text from an original language to a target language;
a speech and emotion synthesis process, configured to capture a speaker's voice and emotions from the original audio and apply them to a text of the target language to synthesize a translated audio of the speaker speaking in the target language; and
a facial translation process, configured to synthesize a facial expression video of the speaker speaking in the target language based on the original video after removing the original audio and the original mouth movement; wherein the facial expression video is then combined with the translated audio to obtain the facial translation video;
wherein the audio extraction process, text recognition process, and video extraction process are grouped into the first process group, and the text translation process, speech and emotion synthesis process, and facial translation process are grouped into the second process group.

10. The real-time facial translation device according to claim 7, wherein the plurality of process groups comprises n process groups, and the plurality of processors comprise n processors and n threads, where n≥2.

11. The real-time facial translation device according to claim 7, wherein the facial translation framework is constructed based on artificial neural networks.
